(19) United States
(12) Patent Application Publication
(10) Pub. No.: US 2025/0105761 A1
(43) Pub. Date: Mar. 27, 2025

(54) BIDIRECTIONAL IMPEDANCE CONTROL NETWORK-BASED AC-DC CONVERTER WITH REACTIVE POWER CAPABILITY

(71) Applicant: Cornell University, Ithaca, NY (US)

(72) Inventors: Khurram K. Afridi, Ithaca, NY (US); Dheeraj Etta, Ithaca, IN (US); Firehiwot Gurara, Ithaca, NY (US); Mausamjeet Khatua, Hillsboro, OR (US)

(21) Appl. No.: 18/900,489

(22) Filed: Sep. 27, 2024

Related U.S. Application Data
(60) Provisional application No. 63/540,854, filed on Sep. 27, 2023.

(51) Int. Cl. H02M 7/797; H02M 1/00; H02M 7/217; H02M 7/5387

(52) U.S. Cl. CPC H02M 7/797; H02M 1/0058; H02M 1/007; H02M 7/217; H02M 7/5387

(57) ABSTRACT

A bidirectional converter includes a first rectifier circuit, a first and second half-bridge inverter circuits, an isolation transformer, a second rectifier circuit, and a network coupled between the half-bridge inverter circuits and the isolation transformer. The network forms an impedance control network (ICN) when the bidirectional converter is operated in a forward operation mode and forms a resistance compression network (RCN) when the bidirectional converter is operated in a reverse operation mode. The bidirectional converter also includes an inductive element established across terminals of the isolation transformer. The inductance of the inductive element, the differential reactance of the network, and the turns ratio of the isolation transformer are determined to ensure zero voltage switching of the high frequency transistors of the bidirectional converter. Additionally, zero voltage switching is promoted by controlling the phase shift between the first and second half-bridge inverter circuits and between legs of the second rectifier circuit.

The present application claims priority to, and the benefit of, U.S. Patent Application Ser. No. 63/540,854, entitled “BIDIRECTIONAL IMPEDANCE CONTROL NETWORK-BASED AC-DC CONVERTER WITH REACTIVE POWER CAPABILITY” by Khurram K. Afridi, which was filed on Sep. 27, 2023, the entirety of which is incorporated herein by reference.

### FIELD OF THE DISCLOSURE

The present disclosure relates generally to power converters and, more particularly, to alternating current-to-direct current (AC-DC) power converters including an impedance control network.

### BACKGROUND

Many broad electric power systems are rapidly transitioning towards generation of energy from nontraditional energy sources such as solar, wind, and energy storage. However, power converters interfaced with such energy sources are generally required to have high-performance across wide operating ranges, and advanced grid-forming and grid-support capability to emulate large inertia synchronous generators and ensure stability. In addition, bidirectional power flow capability may be necessary for those systems using batteries used as backup power supplies.

Currently, the conventional solution for grid-attached converters is a two-stage architecture. The first stage is a front-end Power Factor Correction (PFC) stage that shapes the line current to achieve near-unity power factor in an ac-dc mode of the converter. The second stage of the converter is generally embodied as an isolated dc-dc stage responsible for regulating the output voltage. However, such two-stage approaches can limit the efficiency and power density of the associated converters.

In some implementations, an Impedance Control Network (ICN) architecture are used to address those limitations by providing single-stage power conversion while ensuring soft switching across a wide range of operating points. However, typical ICN converter designs are generally focused only on DC-DC and unidirectional AC-DC power conversion. Additional challenges to typical conventional ICN converter designs can be encountered in the rectification stage because soft switching cannot be maintained in the lagging rectifier leg.

### SUMMARY

According to an aspect of the present disclosure, a bidirectional converter may include a first rectifier circuit, a first half-bridge inverter circuit, a second half-bridge inverter circuit, a network, an isolation transformer, and a second rectifier circuit. The first half-bridge inverter circuit may be electrically coupled to a common terminal of the first rectifier circuit and may include a first plurality of transistors. The second half-bridge inverter circuit may be electrically coupled the common terminal of the first rectifier circuit and may include a second plurality of transistors. The network may have a first terminal electrically coupled to the first half-bridge inverter and a second terminal electrically coupled to the second half bridge inverter. The network be embodied as or otherwise form an impedance control network (ICN) when the bidirectional converter is operated in a forward operation mode and a resistance compression network (RCN) when the bidirectional converter is operated in a reverse operation mode. The isolation transformer may have a first terminal electrically coupled to a third terminal of the network and a pair of second terminals. The second rectifier circuit may be electrically coupled to the pair of second terminals of the isolation transformer and may include a third plurality of transistors. Additionally, the bidirectional converter may include an inductive element established across the pair of second terminals of the isolation transformer. The inductive element may include an inductance selected to produce zero voltage switching of the first, second, and third plurality of transistors.

In some embodiments, the inductive element may be embodied as a magnetizing inductance of the isolation transformer or as a discrete inductor. Additionally, in some embodiments, the inductance of the inductive element may be determined according to the following equation:

$${L}_{ZVS} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} )$$

wherein L_{ZVS} is the inductance of the inductive element, N is the turns ratio of the isolation transformer, fₛ is the switching frequency of the bidirectional converter, V_{in,pk} is the peak value of an alternating current (AC) line voltage, P_{OUT} is the output power, and X is the differential reactance of the network.

Additionally or alternatively, in some embodiments, the inductance of the inductive element may be determined according to the following equation:

$${L}_{ZVS , optimal} = \frac{X}{8 {N}^{2} {f}_{s}}$$

wherein L_{ZVS,optimal} is the inductance of the inductive element, X is the differential reactance of the network, N is the turns ratio of the isolation transformer, and fₛ is the switching frequency of the bidirectional converter.

In some embodiments, the isolation transformer may have a turns ratio, N, determined according to the following equation:

$$N = \frac{\sqrt{{V}_{in , min , pk}^{2} + {V}_{in , max , pk}^{2}}}{2 {V}_{out , min}}$$

wherein V_{in,min,pk} is the peak value of a minimum alternating current (AC) line voltage, V_{in,max,pk} is the peak value of a maximum AC line voltage, and V_{out,min} is the minimum output Direct Current (DC) voltage.

Additionally, in some embodiments, a differential reactance, X, of the network may be determined according to the following equation:

$$X = \frac{2 {V}_{in , min , pk} {V}_{in , max , pk}}{{π}^{2} {P}_{OUT , rated}}$$

wherein V_{in,min,pk} is the peak value of a minimum alternating current (AC) line voltage, V_{in,max,pk} is the peak value of a maximum AC line voltage, and P_{OUT,rated} is the rated output power of the bidirectional converter.

Further, in some embodiments, the bidirectional converter may further include a controller configured to control a phase shift angle, 2Δ, between the first half-bridge inverter circuit and the second half-bridge circuit and a phase shift angle, ϕ, between a first leg of the second rectifier circuit and a second leg of the second rectifier circuit. In such embodiments, the phase shift angle, 2Δ, between the first half-bridge inverter circuit and the second half-bridge circuit is determined according to the following equation:

$$Δ = a tan ( \frac{{π}^{2} {XP}_{OUT}}{2 {v}_{in , pk}^{2}} z )$$

wherein X is the differential reactance of the network, P_{OUT} is the output power, and V_{in,pk} is the peak value of an alternating current (AC) line voltage. Additionally, in such embodiments, the phase shift angle, ϕ, between the first leg of the second rectifier circuit and the second leg of the second rectifier circuit is determined according to the following equation:

$$ϕ = 2 a sin ( \frac{{v}_{in , pk}}{2 N {V}_{OUT}} \sqrt{{v}_{r}^{2} + {( \frac{{π}^{2} {XP}_{OUT}}{2 {v}_{in , pk}^{2}} {zv}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, X is the differential reactance of the network, P_{OUT} is the output power, and Z is a factor value.

According to another aspect of the present disclosure, a converter may include a first rectifier circuit, a first half-bridge inverter circuit, a second half-bridge inverter circuit, an impedance control network, an isolation transformer, and a second rectifier circuit. The first rectifier circuit may have an input configured to receive an alternating current (AC) input signal. Additionally, the first rectifier circuit may be configured to convert the AC input signal to a rectified signal at an output of the first rectifier circuit. The first half-bridge inverter circuit electrically may be coupled to the output of the first rectifier circuit and may include a first plurality of transistors. Additionally, the first half-bridge inverter may be configured to convert the rectified signal to a first Direct Current (DC) signal at an output of the first half-bridge inverter circuit. The second half-bridge inverter circuit may be electrically coupled to the output of the first rectifier circuit and may include a second plurality of transistors. Additionally, the second half-bridge inverter may be configured to convert the rectified signal to a second DC signal at an output of the second half-bridge inverter circuit. The impedance control network may have a first input electrically coupled to the output of the first half-bridge inverter and a second input electrically coupled to the output of the second half bridge inverter. Additionally, the impedance control network may be configured to combine the first DC signal and the second DC signal to generate a third DC signal at an output of the impedance control network. The isolation transformer may have an input electrically coupled to an output of the impedance control network and an output comprising a pair of output terminals. The second rectifier circuit electrically may be coupled to the output of the isolation transformer. Additionally, the second rectifier circuit may include a third plurality of transistors and being configured to convert an output signal of the isolation transformer to a DC output signal. Furthermore, the converter may include inductive element established across the pair of output terminals of the isolation transformer. The inductive element may include an inductance selected to produce zero voltage switching of the first, second, and third plurality of transistors.

In some embodiments, the inductive element may be embodied as a magnetizing inductance of the isolation transformer or as a discrete inductor. Additionally, in some embodiments, the inductance of the inductive element may be determined according to the following equation:

$${L}_{Z V S} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} )$$

wherein L_{ZVS} is the inductance of the inductive element, N is the turns ratio of the isolation transformer, fₛ is the switching frequency of the converter, V_{in,pk} is the peak value of an alternating current (AC) line voltage, P_{OUT} is the output power, and X is the differential reactance of the network.

Additionally or alternatively, in some embodiments, the inductance of the inductive element may be determined according to the following equation:

$${L}_{ZVS , optima1} = \frac{X}{8 {N}^{2} {f}_{s}}$$

wherein L_{ZVS,optimal} is the inductance of the inductive element, X is the differential reactance of the network, N is the turns ratio of the isolation transformer, and fₛ is the switching frequency of the converter.

In some embodiments, the isolation transformer may have a turns ratio, N, determined according to the following equation:

$$N = \frac{\sqrt{{V}_{in , min , pk}^{2} + {V}_{in , max , pk}^{2}}}{2 {V}_{out , min}}$$

wherein V_{in,min,pk} is the peak value of a minimum alternating current (AC) line voltage, V_{in,max,pk} is the peak value of a maximum AC line voltage, and V_{out,min} is the minimum output Direct Current (DC) voltage.

Additionally, in some embodiments, a differential reactance, X, of the network may be determined according to the following equation:

$$X = \frac{2 {V}_{in , min , pk} {V}_{in , max , pk}}{{π}^{2} {P}_{OUT , rated}}$$

wherein V_{in,min,pk} is the peak value of a minimum alternating current (AC) line voltage, V_{in,max,pk} is the peak value of a maximum AC line voltage, and P_{OUT,rated} is the rated output power of the converter.

Further, in some embodiments, the converter may further include a controller configured to control a phase shift angle, 2Δ, between the first half-bridge inverter circuit and the second half-bridge circuit and a phase shift angle, ϕ, between a first leg of the second rectifier circuit and a second leg of the second rectifier circuit. In such embodiments, the phase shift angle, 2Δ, between the first half-bridge inverter circuit and the second half-bridge circuit is determined according to the following equation:

$$Δ = a tan ( \frac{{π}^{2} {XP}_{OUT}}{2 {v}_{in , pk}^{2}} z )$$

wherein X is the differential reactance of the network, P_{OUT} is the output power, and V_{in,pk} is the peak value of an alternating current (AC) line voltage. Additionally, in such embodiments, the phase shift angle, ϕ, between the first leg of the second rectifier circuit and the second leg of the second rectifier circuit is determined according to the following equation:

$$ϕ = 2 a sin ( \frac{{v}_{in , pk}}{2 N {V}_{OUT}} \sqrt{{v}_{r}^{2} + {( \frac{{π}^{2} {XP}_{OUT}}{2 {v}_{in , pk}^{2}} {zv}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, X is the differential reactance of the network, P_{OUT} is the output power, and Z is a factor value.

According to a further aspect of the present disclosure, a method for controlling operation of a bidirectional converter including an impedance control network (ICN) may include determining a ratio, Vᵣ, of a magnitude of the instantaneous line voltage of an alternating current (AC) input signal and determining a reactive power capability factor, Z, as a function of the ratio, Vᵣ. The method may also include determining a phase shift angle, 2Δ, between a first half-bridge inverter circuit and a second half-bridge circuit of the bidirectional converter based on the reactive power capability factor, Z, and determining a phase shift angle, ϕ, between a first leg and a second leg of a rectifier circuit of the bidirectional converter based on the reactive power capability factor, Z. The method may further include controlling operation of a plurality of transistors of the first and second half-bridge inverters circuit based on the phase shift angle, 2Δ, and controlling operation of a plurality of transistors of the rectifier circuit inverter circuit based on the phase shift angle, ϕ.

In some embodiments, determining the phase shift angle, 2Δ, between the first half-bridge inverter circuit and the second half-bridge circuit may include determining the phase shift angle, 2Δ, according to the following equation:

$$Δ = a tan ( \frac{{π}^{2} {XP}_{OUT}}{2 {v}_{in , pk}^{2}} z )$$

wherein X is the differential reactance of the impedance control network, P_{OUT} is the output power, and V_{in,pk} is the peak voltage value of AC input signal.

Additionally, in some embodiments, determining the phase shift angle, ϕ, between a first leg and a second leg of a rectifier circuit comprises determining the phase shift angle, ϕ, according to the following equation:

$$ϕ = 2 a sin ( \frac{{v}_{in , pk}}{2 N {V}_{OUT}} \sqrt{{v}_{r}^{2} + {( \frac{{π}^{2} {XP}_{OUT}}{2 {v}_{in , pk}^{2}} {zv}_{r} )}^{2}} )$$

wherein V_{in,pk} is the peak voltage value of the AC input signal, N is the turns ratio of an isolation transformer of the bidirectional converter, Vₒᵤₜ is the output voltage, Vᵣ is a ratio of the magnitude of an instantaneous voltage of the AC input signal and a peak voltage of the AC input signal, X is the differential reactance of the impedance control network, P_{OUT} is the output power, and Z is the reactive power capability factor.

According to yet a further aspect of the present disclosure, a converter may include a first rectifier circuit, a first half-bridge inverter circuit, a second half-bridge inverter circuit, a network, a multi-winding transformer, and a plurality of second rectifier circuits. The first half-bridge inverter circuit may be electrically coupled to a common terminal of the first rectifier circuit and may include a first plurality of transistors. The second half-bridge inverter circuit may be electrically coupled the common terminal of the first rectifier circuit and may include a second plurality of transistors. The network may have a first terminal electrically coupled to the first half-bridge inverter and a second terminal electrically coupled to the second half bridge inverter. The network be embodied as or otherwise form an impedance control network (ICN) when the bidirectional converter is operated in a forward operation mode and a resistance compression network (RCN) when the bidirectional converter is operated in a reverse operation mode. The multi-winding transformer may have a primary side electrically coupled to the network and a plurality of secondary sides. Each of second rectifier circuits may be coupled to a corresponding secondary side of the multi-winding transformer and includes a third plurality of transistors. In some embodiments, the converter may also include an inductive element established across one or more of the secondary sides. Such inductive elements may have an inductance selected to produce zero voltage switching of the first, second, and third plurality of transistors.

In some embodiments, the turns ratio between the primary side and the secondary sides of the multi-winding transformer (assuming forward operation mode) may be determined according to the following equation:

$${N}_{n} = \frac{\sqrt{{v}_{in , min , pk}^{2} + {v}_{in , max , pk}^{2}}}{{V}_{out , {min}_{n}}}$$

wherein V_{in,min,pk} and V_{in,max,pk} are the peak values of minimum and maximum input line voltages, respectively and V_{out,min} is the minimum output DC voltage for port “n”.

Additionally, in some embodiments, the converter may further include a controller configured to control a phase shift angle, 2Δ, between the first half-bridge inverter circuit and the second half-bridge circuit and a phase shift angle, ϕ, between a first leg of the second rectifier circuit and a second leg of the second rectifier circuit. In such embodiments, the phase shift angle, 2Δ, between the first half-bridge inverter circuit and the second half-bridge circuit is determined according to the following equation:

$$2 Δ = 2 a tan ( \frac{{π}^{2} {XP}_{OUT}}{2 {V}_{in , pk}^{2}} )$$

wherein X is the differential reactance of the network, P_{OUT} is the output power, and V_{in,pk} is the peak value of an alternating current (AC) line voltage. Additionally, in embodiments in which the multi-winding transformer is a current transformer, the phase shift angle, ϕₙ, between the first leg of the “n” second rectifier circuit and the second leg of the “n” second rectifier circuit is determined according to the following equation:

$${ϕ}_{n} = asin ( \frac{{π}^{2} {XP}_{OUT , n} \vert {v}_{in} \vert}{4 sin ( Δ ) {N}_{n} {V}_{OUT , n} {V}_{in , pk}^{2}} )$$

wherein X is the differential reactance of the network, P_{OUT,n} is the output power for port “n”, V_{in,pk} is the line voltage value, Nn is the turns ratio for port “n”, V_{OUT,n} is the output voltage for port “n”, and V_{in,pk} is the peak value of an alternating current (AC) line voltage. Alternatively, in embodiments in which the multi-winding transformer is a voltage transformer, the phase shift angle, ϕₙ, between the first leg of the “n” second rectifier circuit and the second leg of the “n” second rectifier circuit is determined according to the following equation:

$${ϕ}_{n} = asin ( \frac{{π}^{2} {XP}_{OUT} \vert {v}_{in} \vert}{4 sin ( Δ ) {N}_{n} {V}_{OUT , n} {V}_{in , pk}^{2}} )$$

wherein X is the differential reactance of the network, P_{OUT} is the total output power, V_{in,pk} is the line voltage value, Nn is the turns ratio for port “n”, V_{OUT,n} is the output voltage for port “n”, and V_{in,pk} is the peak value of an alternating current (AC) line voltage.

According to yet another aspect of the present disclosure, a converter may include a first rectifier circuit, a first half-bridge inverter circuit, a second half-bridge inverter circuit, a first bridge configuration network, a network, an isolation transformer, a second rectifier circuit, and a second bridge configuration network. The first half-bridge inverter circuit may be electrically coupled to a common terminal of the first rectifier circuit and may include a first plurality of transistors. The second half-bridge inverter circuit may be electrically coupled the common terminal of the first rectifier circuit and may include a second plurality of transistors. The first bridge configuration network may be electrically coupled to each of the first and second half-bridge inverter circuits and may include a third plurality of transistors controllable to configure the first and second half-bridge inverter circuits in either (i) a parallel configuration or (ii) a stacked configuration. The network may have a first terminal electrically coupled to the first half-bridge inverter and a second terminal electrically coupled to the second half bridge inverter. The network may be embodied as or otherwise form an impedance control network (ICN) when the bidirectional converter is operated in a forward operation mode and a resistance compression network (RCN) when the bidirectional converter is operated in a reverse operation mode. The isolation transformer may have a first terminal electrically coupled to a third terminal of the network and a pair of second terminals. The second rectifier circuit may be electrically coupled to the pair of second terminals of the isolation transformer and may include a first half-bridge rectifier circuit including a plurality of fourth plurality of transistors and a second half-bridge rectifier circuit including a plurality of fifth transistor. The second bridge configuration network may be electrically coupled to each of the first and second half-bridge rectifier circuits of the second rectifier circuit and may be include a sixth plurality of transistors controllable to configure the first and second half-bridge rectifier circuits in either (i) a parallel configuration or (ii) a stacked configuration.

In some embodiments, the first half-bridge rectifier circuit of the second rectifier may be electrically coupled to a first output terminal of the pair of second terminals of the isolation transformer and the second half-bridge rectifier circuit of the second rectifier may be electrically coupled to a second output terminal of the pair of second terminals of the isolation transformer. In such embodiments, the converter may further include a pair of diodes electrically coupled across the first half-bridge rectifier circuit. The pair of diodes may be coupled to each other at a common connection point. Additionally, in such embodiments, the converter may also include a capacitor electrically coupled to the common connection point and coupled to the second output terminal of the pair of second terminals of the isolation transformer.

Additionally, in some embodiments, the converter may further include a controller configured to control a phase shift angle, 2Δ, between the first half-bridge inverter circuit and the second half-bridge circuit and a phase shift angle, ϕ, between the first half-bridge rectifier circuit of the second rectifier circuit and the second half-bridge rectifier circuit of the second rectifier circuit.

In such embodiments, when the first and second half-bridge inverter circuits are configured in the parallel configuration by the first bridge configuration network and the first and second half-bridge rectifier circuits are configured in the parallel configuration by the second bridge configuration network, the converter may be configured to (i) determine the phase shift angle, 2Δ, between the first half-bridge inverter circuit and the second half-bridge circuit according to the following equation:

$$Δ = atan ( \frac{{π}^{2} {XP}_{OUT}}{2 {v}_{in , pk}^{2}} )$$

wherein X is the differential reactance of the network, P_{OUT} is the output power, and V_{in,pk} is the peak value of an alternating current (AC) line voltage, and
(ii) determine the phase shift angle, ϕ, between the first half-bridge rectifier circuit of the second rectifier circuit and the second half-bridge rectifier circuit according to the following equation:

$$ϕ = 2 asin ( \frac{{v}_{in , pk}}{2 {N V}_{OUT}} \sqrt{{v}_{r}^{2} + {( \frac{{π}^{2} {XP}_{OUT}}{2 {v}_{in , pk}^{2}} {v}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage, X is the differential reactance of the network, and P_{OUT} is the output power.

Additionally or alternatively, in such embodiments, when the first and second half-bridge inverter circuits are configured in the stacked configuration by the first bridge configuration network and the first and second half-bridge rectifier circuits are configured in the parallel configuration by the second bridge configuration network, the converter may be configured to (i) determine the phase shift angle, 2Δ, between the first half-bridge inverter circuit and the second half-bridge circuit according to the following equation:

$$Δ = atan ( \frac{2 {π}^{2} {XP}_{OUT}}{{v}_{in , pk}^{2}} )$$

wherein X is the differential reactance of the network, P_{OUT} is the output power, and V_{in,pk} is the peak value of an alternating current (AC) line voltage, and
(ii) determine the phase shift angle, ϕ, between the first half-bridge rectifier circuit of the second rectifier circuit and the second half-bridge rectifier circuit according to the following equation:

$$ϕ = 2 asin ( \frac{{v}_{in , pk}}{4 {N V}_{OUT}} \sqrt{{v}_{r}^{2} + {( \frac{2 {π}^{2} {XP}_{OUT}}{{v}_{in , pk}^{2}} {v}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage, X is the differential reactance of the network, and P_{OUT} is the output power.

Additionally or alternatively, in such embodiments, when the first and second half-bridge inverter circuits are configured in the parallel configuration by the first bridge configuration network and the first and second half-bridge rectifier circuits are configured in the stacked configuration by the second bridge configuration network, the converter may be configured to (i) determine the phase shift angle, 2Δ, between the first half-bridge inverter circuit and the second half-bridge circuit according to the following equation:

$$Δ = atan ( \frac{{π}^{2} {XP}_{OUT}}{2 {v}_{in , pk}^{2}} )$$

wherein X is the differential reactance of the network, P_{OUT} is the output power, and V_{in,pk} is the peak value of an alternating current (AC) line voltage, and
(ii) determine the phase shift angle, ϕ, between the first half-bridge rectifier circuit of the second rectifier circuit and the second half-bridge rectifier circuit according to the following equation:

$$ϕ = 2 asin ( \frac{{v}_{in , pk}}{{N V}_{OUT}} \sqrt{{v}_{r}^{2} + {( \frac{{π}^{2} {XP}_{OUT}}{2 {v}_{in , pk}^{2}} {v}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage, X is the differential reactance of the network, and P_{OUT} is the output power.

Additionally or alternatively, in such embodiments, when the first and second half-bridge inverter circuits are configured in the stacked configuration by the first bridge configuration network and the first and second half-bridge rectifier circuits are configured in the stacked configuration by the second bridge configuration network, the converter may be configured to (i) determine the phase shift angle, 2Δ, between the first half-bridge inverter circuit and the second half-bridge circuit according to the following equation:

$$Δ = atan ( \frac{2 {π}^{2} {XP}_{OUT}}{{v}_{in , pk}^{2}} )$$

wherein X is the differential reactance of the network, P_{OUT} is the output power, and V_{in,pk} is the peak value of an alternating current (AC) line voltage, and
(ii) determine the phase shift angle, ϕ, between the first half-bridge rectifier circuit of the second rectifier circuit and the second half-bridge rectifier circuit according to the following equation:

$$ϕ = 2 asin ( \frac{{v}_{in , pk}}{2 {N V}_{OUT}} \sqrt{{v}_{r}^{2} + {( \frac{2 {π}^{2} {XP}_{OUT}}{{v}_{in , pk}^{2}} {v}_{r} )}^{2}} )$$

wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage, X is the differential reactance of the network, and P_{OUT} is the output power.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of an embodiment of an Impedance Control Network (ICN)-based bidirectional single-stage AC-DC converter according to the present disclosure;

FIG. 2 is a simplified circuit diagram of an embodied of the ICN-based bidirectional single-stage AC-DC converter of FIG. 1;

FIG. 3 is a graph illustrating gating signals for the top transistor of leg-A (Q₅), leg-B (Q₇), leg-C (Q₉) and leg-D (Q₁₁) of the ICN-based bidirectional single-stage AC-DC converter of FIG. 1 in ICN (forward) operational mode, with the bottom transistors of all half-bridge legs being driven by the signals complementary to those shown, with short deadtimes;

FIG. 4 is a fundamental frequency model of the ICN-based bidirectional single-stage AC-DC converter of FIGS. 1 and 2;

FIG. 5 is a graph illustrating the instantaneous output power and corresponding mode of operation for unity and non-unity power factor in AC-DC power conversion;

FIG. 6 is a simplified flow diagram of an embodiment of a method for controlling the ICN-based bidirectional single-stage AC-DC converter of FIGS. 1 and 2;

FIG. 7 is a set of graphs illustrating the output voltage, current, and power of the ICN-based bidirectional single-stage AC-DC converter of FIGS. 1 and 2 in forward mode when (a) θ=90° (b) θ=30° and θ=−30° when v_{in,rms}=120 V using the proposed control methodology of FIG. 6;

FIG. 8 is a set of graphs illustrating switch node current and voltage waveforms of the legs A and B in reverse mode when θ=−90° (a), with the converter running as an Impedance Control Network (ICN) for half of the line cycle and as a Resistance Compression Network (RCN) for the second half with soft-switching transitions shown in (b) and (c), respectively;

FIG. 9 is a graph illustrating maximum power profiles of the ICN-based bidirectional single-stage AC-DC converter of FIGS. 1 and 2 in both forward and reverse mode of operation as a function of rectified AC input voltage, for a constant output voltage;

FIG. 10 are graphs illustrating a family of maximum power profiles of the ICN-based bidirectional single-stage AC-DC converter of FIGS. 1 and 2 in both forward and reverse mode of operation as a function of rectified ac input voltage, with varying output voltage;

FIG. 11 are a set of graphs illustrating optimal maximum power profiles of the ICN-based bidirectional single-stage AC-DC converter of FIGS. 1 and 2 in both forward and reverse mode of operation and the desired power profiles at the two extreme input ac voltages for (a) lagging phase between input AC voltage and current and

$$\frac{d \vert {v}_{in} \vert}{dt} \geq 0 ,$$

(b) lagging phase between input AC voltage and current and

$$\frac{d \vert {v}_{in} \vert}{dt} < 0 ,$$

(c) leading phase between input AC voltage and current and

$$\frac{d \vert {v}_{in} \vert}{dt} \geq 0 ,$$

(d) leading phase between input AC voltage and current and

$$\frac{d \vert {v}_{in} \vert}{dt} < 0 ;$$

FIG. 12 are timing diagrams illustrating various waveforms of the ICN-based bidirectional single-stage AC-DC converter of FIGS. 1 and 2 operating using the proposed phase shift methodology;

FIG. 13 is a graph illustrating a required ZVS inductance value to achieve soft switching across entire line cycle with respect to peak input line voltage at various output power levels for unity power factor operation in forward mode;

FIG. 14 is a simplified circuit diagram of an alternative embodiment of a bidirectional ICN-based AC-DC converter with multiple ports on the DC-side;

FIG. 15 is a simplified circuit diagram of an alternative embodiment of a bidirectional ICN-based DC-DC converter;

FIG. 16 is a simplified block diagram of an embodiment of an ICN-based converter including a pair of bridge configuration networks;

FIG. 17 is a simplified circuit diagram of an embodied of the ICN-based converter of FIG. 16;

FIG. 18 is a graph illustrating the switch node voltages, V_{rec1} and V_{rec2}, and the current, I_{rec}, of the two half-bridge rectifiers of the ICN-based converter of FIG. 17 with the half-bridge rectifiers configured in a stacked configuration;

FIGS. 19A-19D are schematic circuit diagrams of the two half-bridge rectifiers of the ICN-based converter of FIG. 17 during different states of operation while in the stacked configuration; and

FIG. 20 is a schematic diagram of the output rectifier circuit, including the two half-bridge rectifiers, including a capacitor voltage balancing circuit.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

A relatively high-efficiency bidirectional Impedance Control Network (ICN)-based AC-DC converter is described below. The illustrative converter employs a design and control methodology that ensures soft-switching of the relevant transistors and enables reactive power capability, soft-switching, and voltage regulation. As discussed further below, an auxiliary zero voltage switching (ZVS) inductor-based approach is implemented to achieve soft-switching in the high frequency transistors on the DC side without affecting the power profile and soft switching properties of the converter in both forward and reverse operational modes. The described control methodology also enables operation of the converter to provide advanced grid-support functionality in DC-AC mode.

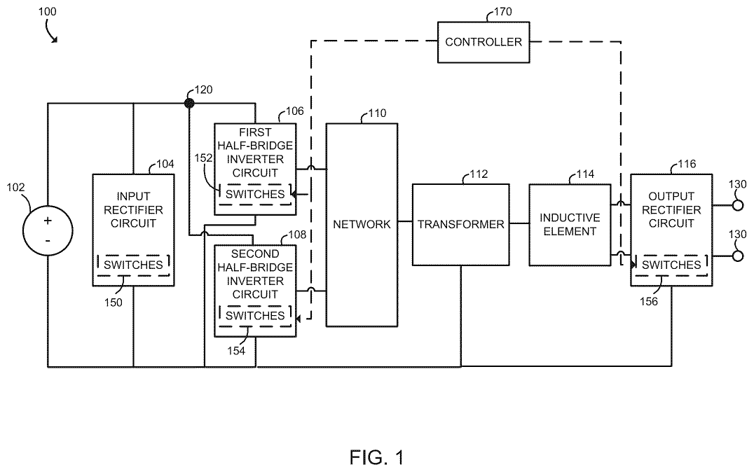

Referring now to FIG. 1, an illustrative ICN-based single-stage bidirectional AC-DC converter 100 includes an AC power source 102, a input rectifier circuit 104, a first half-bridge inverter circuit 106, a second half-bridge inverter circuit 108, a network 110 embodied as an ICN, a transformer 112, an indicative element 114, and an output rectifier 116. The input rectifier circuit 104 includes a number switches 150, based on the topology of the input rectifier circuit 104, and is configured to rectify an input AC voltage (νᵢₙ) received from the AC power source 102. The First half-bridge inverter circuit 106 is coupled to a common terminal 120 of the input rectifier circuit 104 and includes a set of switches 152. Similarly, the second half-bridge inverter circuit 108 is also coupled to the common terminal 120 of the input rectifier circuit 104 and includes a set of switches 154. The switches 152, 154 control operation of the half-bridge inverter circuits 106, 108, respectively.

The network 110 is coupled to each of the first and second half bridge inverter circuits 106, 108. The network 110 is configured to operate as or otherwise embody an Impedance Control Network (ICN) when the bidirectional AC-DC converter 100 is operated in a forward operation mode and configured to operate as or otherwise embody a resistance compression network (RCN) when the bidirectional AC-DC converter 100 is operated in a reverse operation mode.

The transformer 112 is coupled to the network 110 and includes a pair of terminals to which the inductive element 114 is established across. In some embodiments, the inductive element 114 may be embodied as a magnetizing inductance of the transformer 112. Alternatively, in other embodiments, the inductive element 114 may be embodied as a discrete inductor coupled to the pair of terminals of the transformer 112. Regardless, the inductive element 114 has an inductance selected so as to produce zero voltage switching of the switches 152 of the first half-bridge inverter circuit 106, the switches 154 of the second half-bridge inverter circuit, and switches 156 of the output rectifier circuit 116. The output rectifier circuit 116 is coupled to the inductive element/transformer 112 and includes a pair of outputs 130 at which the DC output of the AC-DC converter 100 is produced.

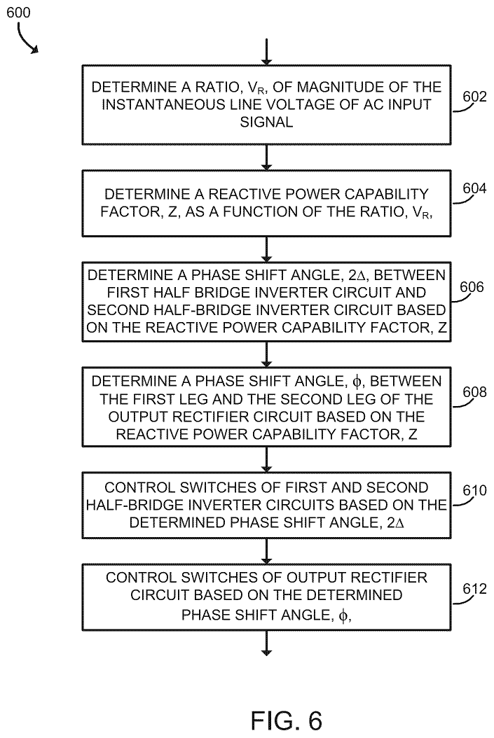

The bidirectional AC-DC converter 100 may also include a controller 170 configured to control operation of the converter 100. That is, the controller 170 is configured to generate switching signals that control the switching of the switches 152 of the first half-bridge inverter circuit 106, the switches 154 of the second half-bridge inverter circuit 108, and the switches 156 of the output rectifier circuit 116. To do so, the controller 170 may employ a control method 600 as described below in regard to FIG. 6 to maintain near zero voltage switching (ZVS) while operating with reactive power capability.

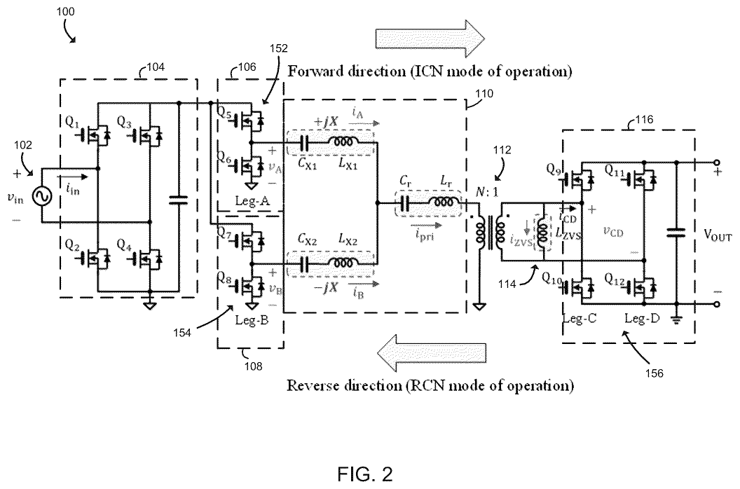

A circuit schematic of an illustrative ICN-based single-stage bidirectional AC-DC converter 200, corresponding to the converter 100 of FIG. 1, is shown in FIG. 2. As discussed above, the input AC voltage (νᵢₙ) from the AC source 102 is rectified by low-frequency full-bridge rectifier 104. The rectified AC voltage appears across the two high-frequency half-bridge inverters 106, 108 (identified as legs A and B in FIG. 2). The output of the inverters 106, 108 is supplied to the ICN 110. In the illustrative embodiment, the ICN 110 is embodied as a power combining network, which comprises of two series resonant tanks designed to have equal and opposite impedances (+jX and −jX) at the converter's switching frequency. The Lᵣ−Cᵣ resonant branch resonates at the switching frequency and is used for harmonic mitigation. The transformer 112, which has a turns ratio N:1, provides galvanic isolation and the a voltage step-up or step-down as needed in the application. Finally, the high-frequency full-bridge rectifier 116 (identified as legs C and D in FIG. 2) interfaces the converter 200 with a DC load (not shown). All the high-frequency switches of the converter 200 are operated at a fixed frequency and a fixed duty cycle (e.g., ˜50%). Power flow in the forward direction, as shown in FIG. 2, is assumed herein to be positive. In the reserve operation mode (i.e., negative power flow), the ICN 110 can be considered as a resistance compression network (RCN) (i.e., a time reverse dual of a ICN), which would include the high-frequency full-bridge inverter 116 (formed by the legs C and D), the transformer 112, the Lᵣ−Cᵣ resonant tank of the network 110, the power splitting network formed by the +jX and −jX legs of the network 110, and the two high-frequency half-bridge rectifiers 106, 108 (formed by the legs A and B). For clarity, the remainder of the description refers to the half-bridge legs in both forward and reverse operational modes as leg A, leg B, leg C, and leg D.

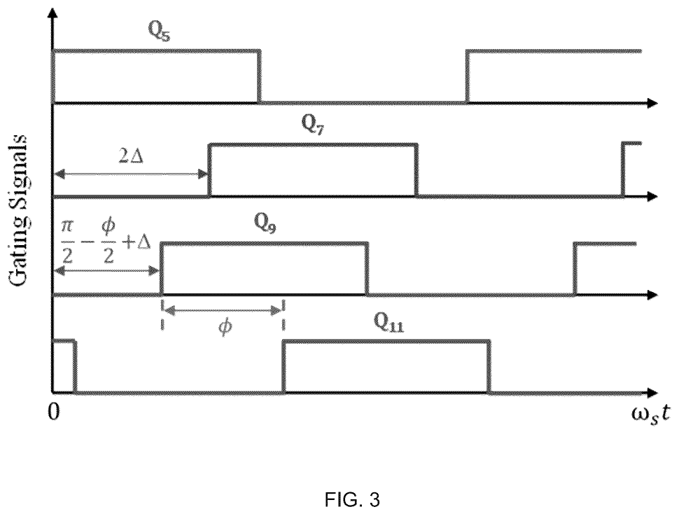

As discussed in more detail below, phase shift modulation between the high-frequency half-bridge legs A, B, C and D may be employed to control the magnitude and direction of the power flow to achieve a desired grid power factor while maintaining the soft-switching of the high-frequency switches 152, 154, 156. In the description below, φ_{XY} denotes the phase lag of leg Y with respect to leg X. Additionally, the phase-shift between legs A and B (φ_{AB}) is denoted by an angle 2Δ, and the phase-shift between legs C and D (φ_{CD}) is denoted by an angle ϕ. The gating signals for the high-frequency transistors 152, 154, 156 denoting all the phase-shifts described above are shown in FIG. 3, with the bottom transistors of all half-bridge legs being driven by the signals complementary to those shown in FIG. 3 It should be appreciated that leg A is the leading leg in forward mode, and leg B is the leading leg in reverse mode. Leg C and leg D remain as leading and lagging legs respectively with a phase-shift of π/2−φ/2+Δ with respect to either leg A (φ_{AC}) in forward mode or leg B (φ_{BC}) in reverse mode as indicated in FIG. 3. The inductive element 114, which may be embodied as an auxiliary zero voltage switching (ZVS) inductor, is connected or otherwise established across the switching nodes of the legs C and D as shown in FIG. 2. The inductive element 114, in conjunction with phase-shift modulation strategy of the method 600 described below, helps to maintain soft-switching of all the high-frequency switches 152, 154, 156 throughout the line cycle. Additionally, it should be noted that the inductive element 114 is coupled in parallel with the transformer 112. As such, the inductive element 114 may be embodied as a discrete inductor or, alternatively, as the magnetizing inductance of the transformer 112, which may lower the component count of the converter 100, 200.

As discussed above, the bidirectional ICN converter 100, 200 designed and controlled to ensure that the converter 100, 200 maintains near-zero current switching across a wide range of voltages and delivers power with unity power factor in the forward mode and with reactive power capability in the reverse operational mode. Using the fundamental circuit model of the converter 100, 200 illustrated in FIG. 3 (and assuming lossless power conversion,) the instantaneous output power in the ICN converter 100, 200 (P_{ICN}) can be expressed as:

$${P}_{ICN} = \frac{8 {N V}_{OUT} \vert {v}_{in} \vert sin ( Δ ) sin ( \frac{ϕ}{2} )}{{π}^{2} X} . \qquad ( 1 )$$

The instantaneous AC voltage νᵢₙ is a sinusoidal waveform and can be given by νᵢₙ=ν_{in,pk} sin (ωt+β), wherein ν_{in,pk} is the peak of the AC line voltage and β is the phase angle of the AC line voltage. Similarly, the instantaneous AC current can be given by iᵢₙ=i_{in,pk} sin (ωt+α), wherein i_{in,pk} is the peak of the AC line current and α is the current phase angle relative to the AC line voltage. The general instantaneous power expression for AC-DC/DC-AC power conversion is the sum of both the real and reactive power, which is given by:

$${P}_{inst} = 2 {P}_{OUT} ( cos ( β - α ) {sin}^{2} ( ω t + β ) + sin ( β - α ) sin ( ω t + β ) cos ( ω t + β ) ) , \qquad ( 2 )$$

where ω is the line frequency. To further simplify and generalize the instantaneous power expression, β can be set to 0°. As such, the term sin (ωt+β) in (2) can be expressed as a ratio of the magnitude of the instantaneous AC line voltage νᵢₙ and ν_{in,pk} as follows:

$$sin ( ω t ) = \frac{\vert {v}_{in} \vert}{{v}_{in , pk}} = {v}_{r} , \qquad ( 3 )$$

wherein νᵣ is the ratio of the two voltages. From Equation (2), the sign of the term cos (ωt+β) varies based on the rate of change of the instantaneous ac voltage,

$$\frac{d \vert {v}_{in} \vert}{dt} .$$

Thus, Pᵢₙₛₜ can further be generalized as:

$${P}_{inst} = 2 {P}_{OUT} ( cos ( θ ) {v}_{r}^{2} ∓ sin ( θ ) \sqrt{1 - {v}_{r}^{2}} {v}_{r} ) , \qquad ( 4 )$$

wherein θ is β−α. A sum or a difference is used in Equation (4) based on whether

$$\frac{d \vert {v}_{in} \vert}{dt}$$

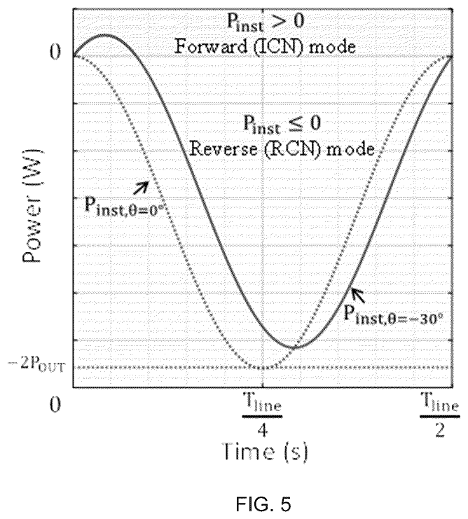

is positive or negative, respectively, along each quarter of a line cycle. The bidirectional ICN converter 100, 200 is operated to ensure that its instantaneous power matches with the general instantaneous power profile of AC-DC/DC-AC converters as provided by Equation (2) for a given power factor as shown in FIG. 5. Thus, equating Equation (1) and Equation (4) correlates the intra-bridge phase-shift control handles, Δ and ϕ, as given by:

$$sin ( Δ ) sin ( \frac{ϕ}{2} ) = \frac{{π}^{2} {XP}_{OUT}}{4 {V}_{OUT} {v}_{in , pk}} {z v}_{r} , \qquad ( 5 )$$

wherein

$$z = \frac{{v}_{r} cos ( θ ) ∓ sin ( θ ) \sqrt{( 1 - {v}_{r}^{2} )}}{{v}_{r}}$$

is a factor used to ensure reactive power capability using the phase shift control handles when the converter operates as an RCN. It should be appreciated that the magnitude of the phase difference between the voltage and current, θ, can range from 0° to ±180°. The forward operation of the ICN converter (i.e., AC-DC mode) may be controlled to ensure near-unity power factor (θ=0°). However, in DC-AC mode, the power factor is not necessarily unity as the converter 100, 200 may need to provide reactive power support to the grid (if so attached). Thus, when the power factor is not unity, the converter 100, 200 operates in forward mode until the voltage along the line cycle reaches the current zero-crossing. Several combinations of Δ and ϕ can satisfy Equation (5). Distinct values can be determined by considering the near zero-current switching (ZCS) constraint of the rectifier transistors to ensure soft switching in DC-AC mode as given by:

$$cos ( Δ ) sin ( \frac{ϕ}{2} ) = \frac{\vert {v}_{in} \vert}{2 {N V}_{OUT}} . \qquad ( 6 )$$

The ratio of Equation (5) and Equation (6), which gives a distinct value for Δ, can be used to unsure soft-switching operation and is given by:

$$Δ = atan ( \frac{{π}^{2} {XP}_{OUT}}{2 {v}_{in , pk}^{2}} z ) . \qquad ( 7 )$$

The value of ϕ, which is used for regulating power in the converter 100, 200 can also be determined by substituting the equivalent expression of sin (Δ) in Equation (5) from Equation (7) and is given by:

$$ϕ = 2 asin ( \frac{{v}_{in , pk}}{2 {N V}_{OUT}} \sqrt{{v}_{r}^{2} + {( \frac{{π}^{2} {XP}_{OUT}}{2 {v}_{in , pk}^{2}} {z v}_{r} )}^{2}} ) . \qquad ( 8 )$$

Using the above analysis and methodology, the converter 100, 200 is designed to operate with reactive power processing capability. To do so, the converter 100, 200 may be controlled using a method 600 as shown in FIG. 6. The method 600 may be executed by, for example, the controller 170, which is configured to generate control signals to control the switching of the switches 152 of the first half-bridge inverter circuit 106, the switches 154 of the second half-bridge circuit 108, and the switches 156 of the output rectifier circuit 116.

The method 600 begins with block 602 in which a ratio, Vr, of the magnitude of the instantaneous line voltage of the AC input signal of the AC power source 102. To do so, the controller 170 may utilize the Equation (3) described above or is otherwise a given or known quantity. In block 604, the controller 10 may determine a reactive power capability factor, Z, as a function of the ratio, Vr. In some implementations, the reactive power capability factor, Z, may be a known or given quantity or, in other embodiments, may be determined by the equation:

$$z = \frac{{v}_{r} cos ( θ ) ∓ sin ( θ ) \sqrt{( 1 - {v}_{r}^{2} )}}{{v}_{r}} ,$$

as a function of the ratio, Vr.

After the controller 170 obtains (e.g., retrieves or calculates) the ratio, Vr, of the magnitude of the instantaneous line voltage of the AC input signal of the AC power source 102 and the reactive power capability factor, Z, the method 600 advances to block 606. In block 606, the controller 10 determines a phase shift angle, 2Δ, between the first half bridge inverter circuit and the second half-bridge inverter circuit based on the reactive power capability factor, Z. To do so, the controller 170 may employ the Equation (7) described above.

Additionally, in block 608, the controller 170 determine the phase shift angle, ϕ, between the first leg C and the second leg D of the output rectifier circuit 116 based on the reactive power capability factor, Z. To do so, the controller 170 may employ the Equation (8) described above.

After the controller 170 has determined the phase shift angle, 2Δ, and the phase shift angle, ϕ, the controller 170 may control the switches 152 of the first half-bridge inverter circuit 106 and the switches 154 of the second half-bridge inverter circuit 108 based on the determined phase shift angle, 2Δ, in block 610. Additionally, in block 612, the controller 170 may control the switches 156 of the output rectifier circuit 116 based on the determined phase shift angle, ϕ.

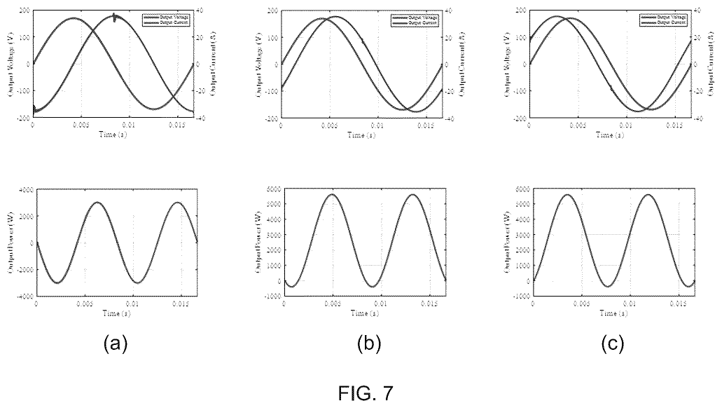

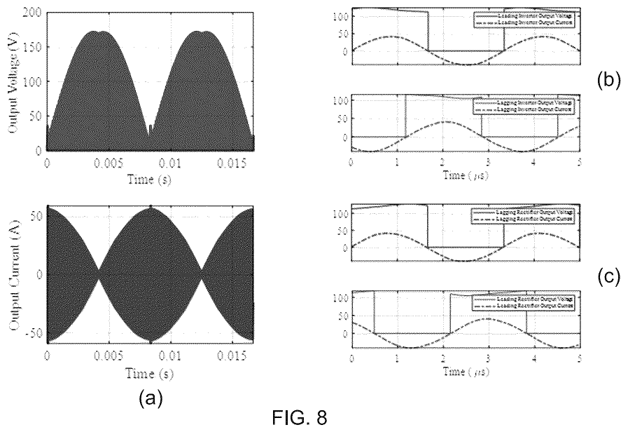

In the illustrative embodiment, when the converter 100, 200, runs in the forward mode, the values of Δ and ϕ are determined by setting the reactive power capability factor, Z, to 1 to ensure unity power factor. When the converter 100, 200 is operated in the reverse mode, FIG. 7 illustrates the resulting output voltage waveforms (FIG. 7A), the output current waveforms (FIG. 7B), and the output power waveforms (FIG. 7C) of the half-bridge rectifier 106, 108 legs A and B when the converter 100, 200 is operated in the reverse mode with θ=0°, θ=30° and θ=−30°. As illustrated, the output current and output power are sinusoidal using the control method 600. In addition to ensuring sinusoidal output, the control method 600 also ensures soft-switching operation of the transistors in legs A and B (i.e., in the half-bridge inverter circuits 106, 108). Such soft-switching is illustrated in FIG. 8, both during forward and reverse operation of the converter when θ=−90°. The converter 100, 200 is configured to operate in forward and reverse modes within its half line cycle depending on the direction of power flow while maintaining near-ZCS and ZVS behavior. Using the above-described power factor-based control methodology of method 600, the converter 100, 200 can be controlled to provide the desired reactive power needed for grid-support during overvoltage and under voltage conditions. During nominal operation condition, the grid voltage is set using the appropriate voltage, frequency, and phase to form a grid-forming inverter.

In addition to the control method 600 described above, the ICN-based bidirectional single-stage ac-dc converter 100, 200 is configured to efficiently process the required power levels at desired grid power factors across its entire input AC voltage and output DC voltage ranges. To do so, the differential reactance X, transformer turns ratio N and auxiliary ZVS inductor L_{ZVS}, are appropriately determined and configured. In determining the differential reactance and transformer turns ratio, the maximum power profile of the converter in both forward and reverse operation modes is initially considered. By imposing the ZVS and near-ZCS criteria of Equation (6) for the half-bridge inverter circuit 106, 108 legs A and B in the Equation (1), the output power expression of the ICN converter 100, 200 can be expressed as

$${P}_{ICN} = \pm \frac{4 \vert {v}_{in} \vert}{{π}^{2} X} \sqrt{4 {N}^{2} {V}_{OUT}^{2} {sin}^{2} ( \frac{ϕ}{2} ) - {\vert {v}_{in} \vert}^{2}} , \qquad ( 9 )$$

wherein + sign indicates forward operation mode (i.e., ICN mode of operation) and − sign indicates reverse operation mode (i.e., RCN mode of operation). As can be discerned from Equation (9), at any input and output voltages, power processed by the ICN converter 100, 200 in each mode is maximum when the phase-shift ϕ between legs C and D of the output rectifier circuit 116 is equal to π. The maximum power profile of the ICN converter 100, 200 in each mode can therefore be expressed as:

$${P}_{ICN , max} = \pm \frac{4 \vert {v}_{in} \vert}{{π}^{2} X} \sqrt{4 {N}^{2} {V}_{OUT}^{2} - {\vert {v}_{in} \vert}^{2}} . \qquad ( 10 )$$

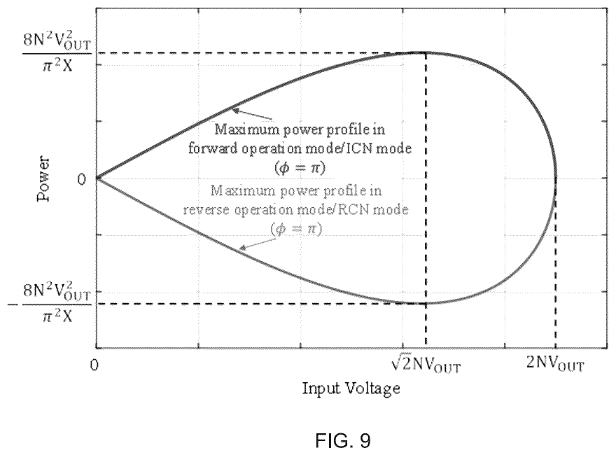

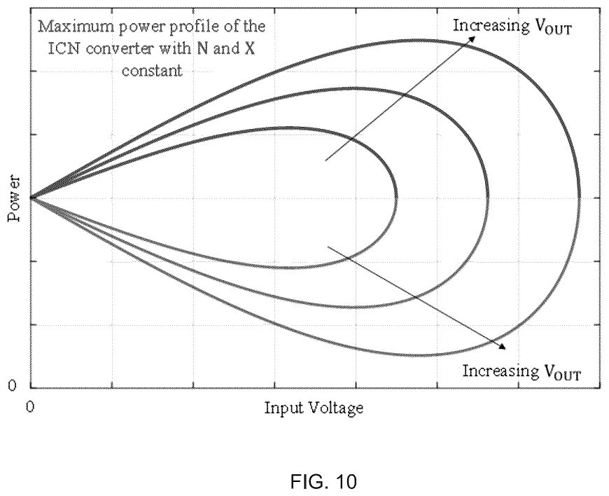

FIG. 9 illustrates the maximum power profiles of the ICN converter 100, 200 with respect to the rectified input line voltage |νᵢₙ| in both operating modes. For the desired operation of the ICN converter 100, 200 across the entire input AC voltage and output DC voltage ranges, the desired power profiles for required power levels and grid power factors across the entire operating range is controlled to be within the maximum power profiles of the ICN converter 100, 200 shown in FIG. 9. FIG. 10 illustrates a family of maximum profiles for different values of output DC voltages. As shown in FIG. 10, as output voltage (V_{OUT}) is increased, the maximum power profile expands in both power and input voltage dimensions. Therefore, to design an ICN converter 100, 200 suitable for wide operating conditions, it is desirable that the desired power profiles across the entire input line voltage range fall within the maximum power profile of the ICN converter 100, 200 at minimum output voltage (V_{OUT,min}) and rated output power (P_{OUT,rated}).

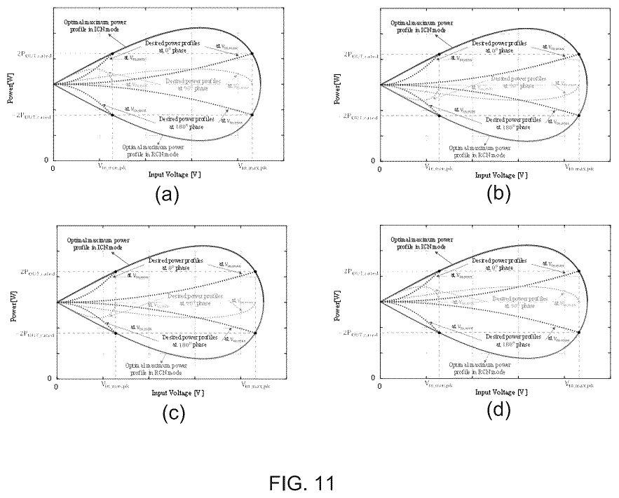

One design for achieving the attributes described above is shown in FIG. 11. In FIG. 11, the desired power profiles for various grid power factors are plotted in dotted lines for the two extreme values of input line voltage (for example, the two extremes of universal input). The power profiles at other than unity power factor vary depending on the line angle and leading/lagging phase. FIG. 11 illustrates the power profiles in those scenarios at two extreme input line voltages, and illustrates that an “optimal” maximum profile lies on or above all the desired power profiles. The desired power profiles at other intermediate input line voltages lie in between these two extreme line voltage curves. For a given rated output power P_{OUT,rated}, all the desired power profiles have the same instantaneous power of 2P_{OUT,rated} or −2P_{OUT,rated} at positive or negative unity power factor, respectively, occurring at the peaks of their respective line voltages. As such, the ICN converter 100, 200 may be designed according to FIG. 10 such that its maximum power capability equals the instantaneous power 2P_{OUT,rated} and −2P_{OUT,rated} at the peaks of the two extreme input line voltages at positive and negative unity power factors, respectively. Imposing those conditions results in the following expressions for the transformer turns ratio N and differential reactance X:

$$N = \frac{\sqrt{{V}_{in , min , pk}^{2} + {V}_{in , max , pk}^{2}}}{2 {V}_{out , min}} , \qquad ( 11 )$$

$$X = \frac{2 {V}_{in , min , pk} {V}_{in , max , pk}}{{π}^{2} {P}_{OUT , rated}} , \qquad ( 12 )$$

wherein V_{in,min,pk} and V_{in,max,pk} are the peak values of minimum and maximum input line voltages, respectively and V_{out,min} is the minimum output DC voltage.

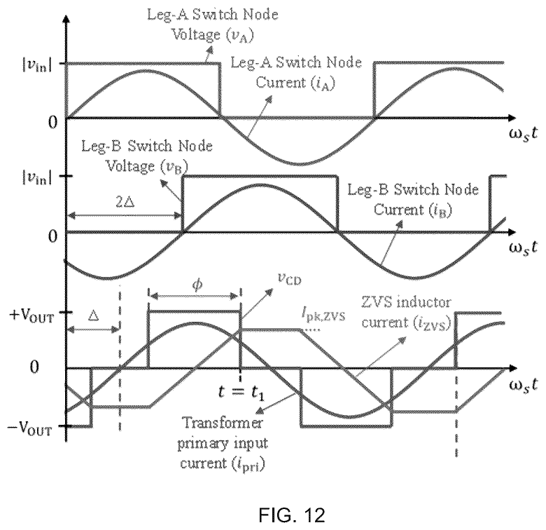

To determine an appropriate design of the auxiliary ZVS inductor 114 (i.e., magnetizing inductance of the transformer) for achieving ZVS of legs C and D of the output rectifier circuit 116 across the wide operating ranges, the high-frequency half bridge leg that poses the limiting condition for soft-switching is initially determined. Auxiliary ZVS inductor 114 has no impact on the expressions of Δ and ϕ or the basic operation of the converter, since it just comes across the switch nodes of legs C and D of the output rectifier circuit 116 and only effects the total current going into the legs C and D, thereby influencing the soft-switching performance of legs C and D. FIG. 12 illustrates various high-frequency half-bridge legs' switch node voltages and currents under the phase shift methodology of method 600 described above. For example, if the auxiliary ZVS inductance 114 (i.e., magnetizing inductance of the transformer) is assumed to be significantly large, the ZVS current, i_{ZVS}, is negligible. Under such conditions, current flowing into or out of leg C or leg D (i_{CD}) of the output rectifier circuit 116 (see FIG. 2) can be expressed as the product of transformer's 114 primary current (iₚᵣᵢ) and the transformer's turns ratio (N). By analyzing the transformer's primary current (iₚᵣᵢ) with respect to rising and falling edges of voltage ν_{CD} shown in FIG. 12, it can be seen that in the absence of ZVS current, leg D and leg Close soft switching in the forward and reverse operation modes, respectively. Such a situation implies that leg D and leg C present the limiting conditions for the design of ZVS inductor in forward and reverse operation modes, respectively.

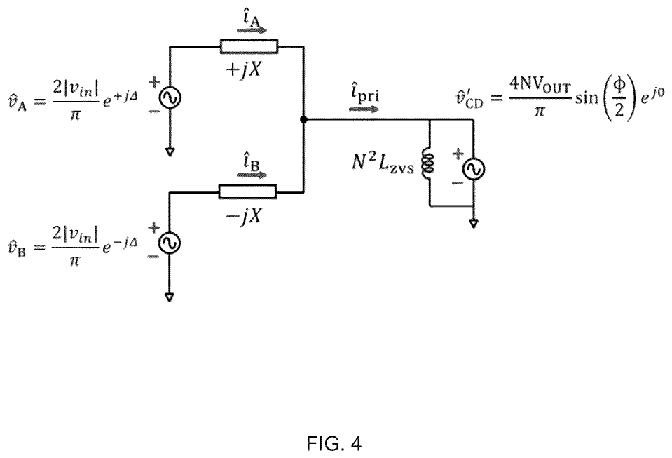

For the ease of explanation, only derivation of ZVS inductance (L_{ZVS}) in unity input power factor operation in forward mode is discussed below, which means leg D poses limiting condition for soft switching. However, similar procedures can be replicated for different power factor operations as well. Using the equivalent circuit model of the converter 200 shown in FIG. 4, transformer primary-side current can be expressed in terms of system parameters as:

$${\hat{ι}}_{pri} = {\hat{ι}}_{A} + {\hat{ι}}_{B} = \frac{4 \vert {v}_{in} \vert}{π X} sin ( Δ ) {e}^{j 0} . \qquad ( 13 )$$

The value of the ZVS inductance 114 should be selected such that the net current (sum of both transformer secondary current and ZVS current) through leg D has zero value at the rising and falling edges of their switch node voltages. Therefore, to achieve ZVS of the leg D, transformer primary side current at the rising edge of the switch node voltage of leg D should be less than or equal to the peak value of the ZVS current transformed to primary side of the transformer (I′_{pk,ZVS}). Accordingly, using Equation (13), the transformer primary side current at the rising edge of the switch node voltage of leg D in forward operation can be obtained as:

$${i}_{pri} ( t = {t}_{1} ) = \frac{4 \vert {v}_{in} \vert}{π X} sin ( Δ ) cos ( \frac{ϕ}{2} ) . \qquad ( 14 )$$

wherein t₁ is the instant when the switch node voltage of the leg D rises as highlighted in FIG. 5. The peak value of the transformed version of the ZVS current (I′_{pk,ZVS}) can be expressed as:

$${I}_{pk , ZVS}^{′} = \frac{{V}_{OUT} ϕ}{4 π {f}_{s} {NL}_{ZVS}} , \qquad ( 15 )$$

wherein fₛ is the converter's 100, 200 switching frequency. For unity input power factor operation in forward mode, using Euqatons (7), (8), (13) and (14), the required ZVS inductance (L_{ZVS}) can be determined as:

$${L}_{ZVS} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} ) \frac{ϕ}{sin ( ϕ )} . \qquad ( 16 )$$

For a given peak input line voltage (V_{in,pk}), output voltage (V_{OUT}) and output power (P_{OUT}) at unity power factor operation in forward mode, the phase-shift ϕ in Equation (8) rises monotonically with the instantaneous value of the rectified input line voltage (|νᵢₙ|), with a value of zero at the input voltage zero crossing. Using that constraint, it can be determined from Equation (16) that the required value of ZVS inductance is minimum in a line cycle when the phase-shift ϕ is zero (i.e., at the input line voltage zero crossing). Therefore, the ZVS inductance value to ensure ZVS of the leg D across entire line cycle under unity power factor operation in forward mode can be determined using Equation (16) as:

$${L}_{ZVS} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} ) . \qquad ( 17 )$$

It should be appreciated that, based on Equation (17), the ZVS inductance value needed to ensure soft switching of the lagging rectifier leg across entire line cycle is independent of the output voltage (V_{OUT}). To determine the optimal value of ZVS inductance L_{ZVS} that can ensure soft switching across entire line cycle and the wide operating range, Equation (17) can be minimized with respect to peak input line voltage. Such minimization results in following expression for the optimal ZVS inductance L_{ZVS,optimal}:

$${L}_{ZVS , optimal} = \frac{X}{8 {N}^{2} {f}_{s}} . \qquad ( 18 )$$

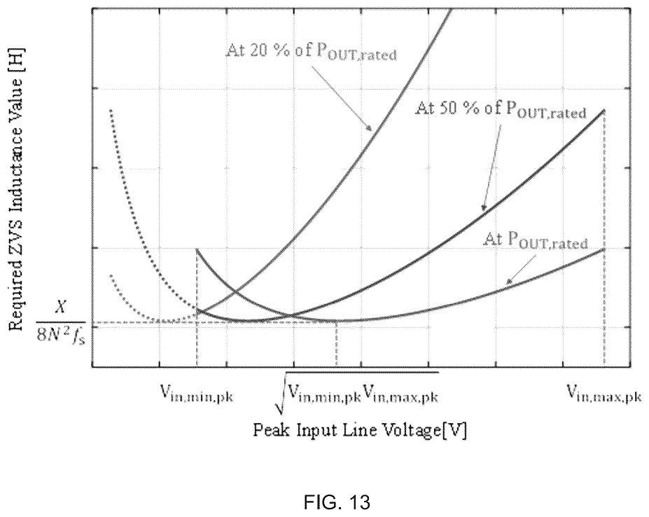

FIG. 13 illustrates required ZVS inductance values to ensure soft switching across entire line cycle for various peak input line voltages at different output power levels. As can be seen, the “optimal” ZVS inductance value given by Equation (18) is appropriate to ensure soft switching across entire input and output voltage ranges and also at various output power levels for unity power factor operation in forward mode.

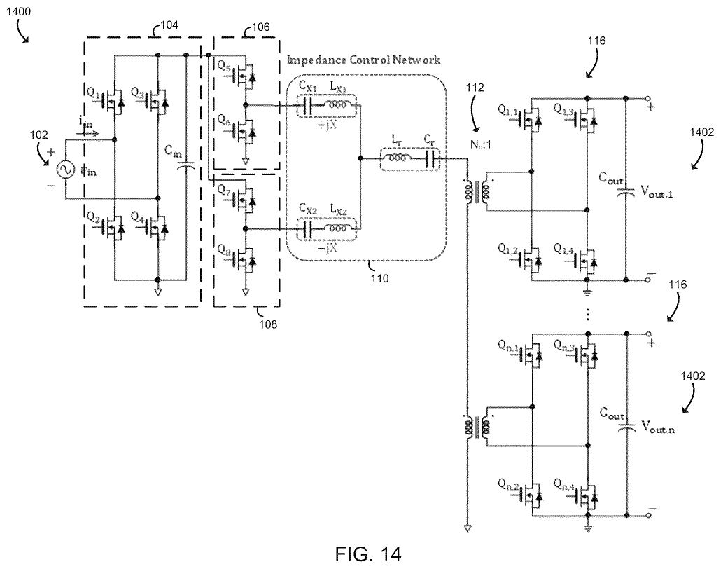

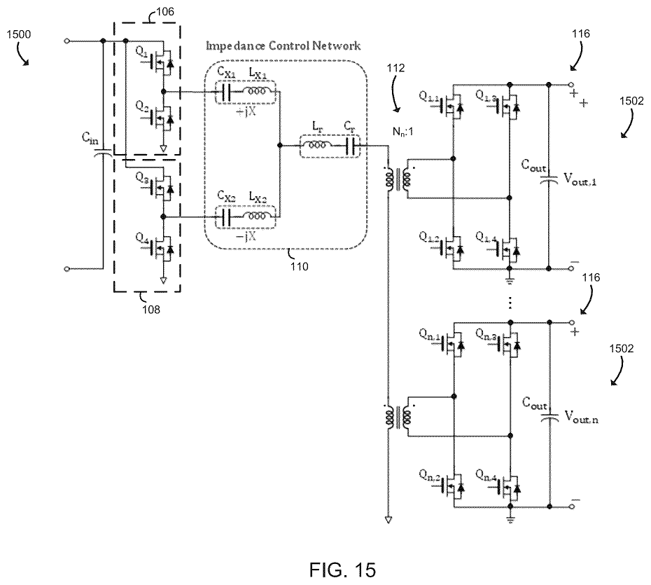

Although the technologies disclosed herein have been described in regard to the illustrative ICN-based single-stage bidirectional AC-DC converter 100, 200, it should be appreciated that such technologies may be usable with other types of converters. For example, the disclosed control methodologies and design parameters may be used in a bidirectional ICN-based AC-DC converter 1400 having multiple output ports 1402 on the DC side as shown in FIG. 14. Alternatively, the disclosed control methodologies and design parameters may be used in an ICN-based DC-DC converter 1500, which may also include multiple outputs ports 1502 as shown in FIG. 15.

For each of the converters 1400, 1500, the transformer 112 may be embodied as a voltage or current transformer. In such embodiments, the turns ratio between the primary side and the secondary side of the transformer (assuming forward operation mode) can be determined based on the minimum DC output voltages corresponding to each port “n” is given by:

$${N}_{n} = \frac{\sqrt{{v}_{in , min , pk}^{2} + {v}_{in , max , pk}^{2}}}{{v}_{out , {min}_{n}}} \qquad ( 19 )$$

wherein V_{in,min,pk} and V_{in,max,pk} are the peak values of minimum and maximum input line voltages, respectively and V_{out,min} is the minimum output DC voltage for port “n”.

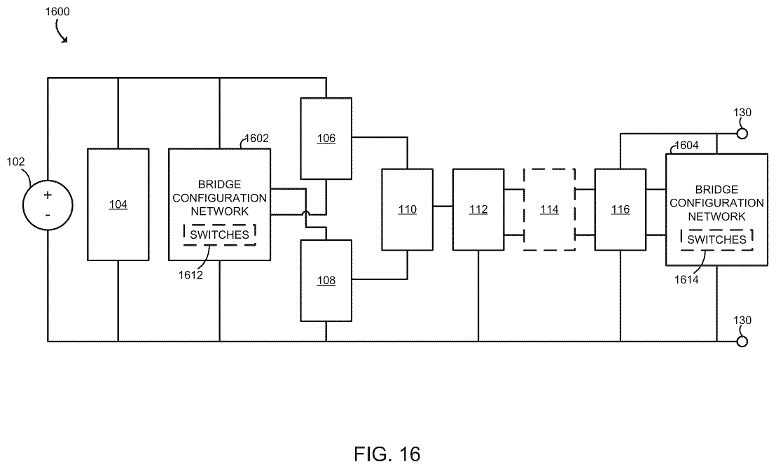

In the multi-port embodiments of FIGS. 14 and 15, the controller 170 can control operation of the converters 1400, 1500 using the phase-shift control handles, phase-shift control handles, Δ and ϕ, as discussed above. However, in the converter 1400, 1500 embodiments of FIGS. 14 and 16, the phase shift angle, 2Δ, between the first half-bridge inverter circuit and the second half-bridge circuit continues to depend of the total output power processed by the respective converter 1400, 1500, P_{OUT}, and can be determined according to the following equation:

$$2 Δ = 2 atan ( \frac{{π}^{2} {XP}_{OUT}}{2 {V}_{in , pk}^{2}} ) \qquad ( 20 )$$

wherein X is the differential reactance of the network, P_{OUT} is the output power, and V_{in,pk} is the peak value of an alternating current (AC) line voltage.

However, the value of the phase shift angle, ϕ, between the first leg of the second rectifier circuit and the second leg of the second rectifier circuit varies based on whether the transformer 112 is embodied as a current transformer or a voltage transformer. For embodiments using a current transformer, the value of the phase shift angle, ϕ, for port “n” depends on the output power of the corresponding port, P_{OUT,n}, and can be determined by:

$${ϕ}_{n} = asin ( \frac{{π}^{2} {XP}_{OUT} \vert {v}_{in} \vert}{4 sin ( Δ ) {N}_{n} {V}_{OUT , n} {V}_{in , pk}^{2}} ) \qquad ( 21 )$$

wherein X is the differential reactance of the network, P_{OUT,n} is the output power for port “n”, V_{in,pk} is the line voltage value, Nn is the turns ratio for port “n”, V_{OUT,n} is the output voltage for port “n”, and V_{in,pk} is the peak value of an alternating current (AC) line voltage.

Conversely, if the transformer is 112 is embodied as a voltage transformer, the value of the phase shift angle, ϕ, for port “n” depends on the total output power of the corresponding converter, P_{OUT}, and can be determined by:

$${ϕ}_{n} = asin ( \frac{{π}^{2} {XP}_{OUT} \vert {v}_{in} \vert}{4 sin ( Δ ) {N}_{n} {V}_{OUT , n} {V}_{in , pk}^{2}} ) \qquad ( 22 )$$

wherein X is the differential reactance of the network, P_{OUT} is the total output power, V_{in,pk} is the line voltage value, Nn is the turns ratio for port “n”, V_{OUT,n} is the output voltage for port “n”, and V_{in,pk} is the peak value of an alternating current (AC) line voltage.

Referring now to FIGS. 16-22, it should be appreciated, that under certain conditions, the circulating currents of an ICN-based converter (e.g., converter 100, 200) may increase with the output voltage on the high-frequency side, which could result in a drop in overall efficiency at higher output voltages. As such, in some embodiments, an ICN-based converter 1600 may include a bridge configuration network 1602 and/or a bridge configuration network 1604 as shown in FIG. 16. The bridge configuration network 1602 includes a set of switches 1612 that are controllable to configure the first half-bridge inverter circuit 106 and the second half-bridge inverter circuit 108 in either a parallel configuration or a stacked configuration. Similarly, the bridge configuration network 1604 includes a set of switches 1614 that are controllable to configure the first half-bridge rectifier circuit 1606 (i.e., leg C) and the second half-bridge rectifier circuit 1608 (i.e., leg D) either a parallel configuration or a stacked configuration. The switches 1612, 1614 may be controlled by, for example, the controller 170 (not shown in FIG. 16 for clarity).

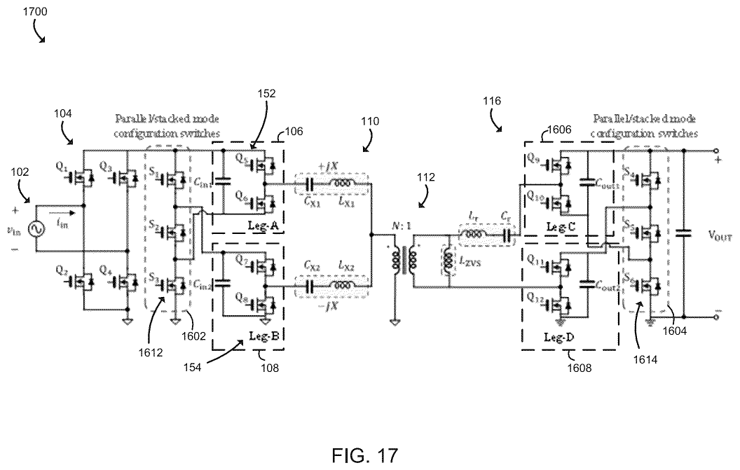

A circuit schematic of an illustrative ICN-based converter 1700 including the bridge configuration network 1602 and the bridge configuration network 1604 is shown in FIG. 17. As described in more detail below, the inclusion of the bridge configuration networks 1602, 1604 effectively compresses the range of voltages to the ICN-based converter 1700 by operating its two half-bridge inverters 106, 108 and two half-bridge rectifiers 1606, 1608 in parallel at low input and output voltages and in a stacked configuration at high input and output voltages. Such a control methodology reduces the voltage stress on the high-frequency transistors used in the converter 1700. Additionally, configuring the two half-bridge rectifiers 1606, 1608 in the stacked configuration also improves the efficiency of the converter 1700 at higher output voltages by reducing circulating currents. Furthermore, configuring the two half-bridge inverters 106, 108 in the stacked configuration can reduce the size of the magnetic components of the converter 1700.

As shown in FIG. 17, the switches 1614 (S₄, S₅, and S₆) of the bridge configuration network 1604 are controllable by the controller 170 to configure the two half-bridge rectifiers 1606, 1608 (leg-C and leg-D) either in a parallel configuration (by keeping S₄ and S₆ on and S₆ off) or in stacked configuration (by keeping S₄ and S₆ off and S₅ on). In the stacked configuration mode operation, a factor-of-two voltage step-down can be achieved in the rectifier input voltage as each half-bridge rectifier 1606, 1608 sees half of the DC output voltage. As such, by operating the half-bridge rectifiers 1606, 1608 in the parallel configuration at lower output voltages and in stacked configuration at higher output voltages, the range of the output voltages seen by the converter 1700 can be effectively compressed. It should be appreciated that a narrower output voltage range may result in lower peak voltages across the switches 156 of the output rectifier circuit 116 and lower circulating currents on the rectifier-side at higher output voltages, thereby improving the efficiency of the converter 1700 at higher output voltages. Furthermore, instead of using an additional DC blocking capacitor, the capacitor Cᵣ of the Lᵣ−Cᵣ resonant branch is used for blocking dDCc voltage from output rectifier circuit 116 when the half-bridge rectifiers 1606, 1608 are operated in the stacked configuration.

Similarly, the switches 1612 (S₁, S₂, and S_{\3}) of the bridge configuration network 1602 are controllable by the controller 170 to configure the two half-bridge inverters 106, 108 (leg-A and leg-B) either in a parallel configuration (by keeping S₁ and S₃ on and S₂ off) or in stacked configuration (by keeping S₁ and S₃ off and S₂ on). Again, by using the combination of parallel and stacked configuration mode of operation on the half-bridge inverters 106, 108, the effective range of input line voltages seen by the converter 100 can be compressed. Additionally, it should be appreciated that narrower input voltage range can result in an improved converter performance due to reduction in the RMS current through rectifier transistors, the resonant inductance requirement, and the step-down requirement from the transformer.

As discussed above, the controller 170 is configured to control the phase shift angle, 2Δ, between the first half-bridge inverter 106 and the second half-bridge inverter 108 and a phase shift angle, ϕ, between the first half-bridge rectifier 1606 and the second half-bridge rectifier 1608. Given that each of the half-bridge inverters 106, 108 and the half-bridge rectifiers 1606, 1608 can be operated in two different configurations (i.e., a parallel configuration or a stacked configuration), the controller 170 may be configured to control the phase shift angles, 2Δ and ϕ, using one of four different sets of equations.

When both of the half-bridge rectifiers 1606, 1608 and the half-bridge rectifiers 1606, 1608 are configured in the parallel configuration, the phase shift angles, 2Δ and ϕ, can be determined as:

$$Δ = atan ( \frac{{π}^{2} {XP}_{OUT}}{2 {v}_{in , pk}^{2}} ) \qquad ( 23 )$$

$$ϕ = 2 asin ( \frac{{v}_{in , pk}}{2 {N V}_{OUT}} \sqrt{{v}_{r}^{2} + {( \frac{{π}^{2} {XP}_{OUT}}{2 {v}_{in , pk}^{2}} {v}_{r} )}^{2}} ) \qquad ( 24 )$$

wherein X is the differential reactance of the network, P_{OUT} is the output power, V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, and X is the differential reactance of the network.

Alternatively, when the half-bridge rectifiers 1606, 1608 are configured in the stacked configuration and the half-bridge rectifiers 1606, 1608 are configured in the parallel configuration, the phase shift angles, 2Δ and ϕ, can be determined as:

$$Δ = atan ( \frac{2 {π}^{2} {XP}_{OUT}}{{v}_{in , pk}^{2}} ) \qquad ( 25 )$$

$$ϕ = 2 asin ( \frac{{v}_{in , pk}}{4 {N V}_{OUT}} \sqrt{{v}_{r}^{2} + {( \frac{2 {π}^{2} {XP}_{OUT}}{{v}_{in , pk}^{2}} {v}_{r} )}^{2}} ) \qquad ( 25 )$$

wherein X is the differential reactance of the network, P_{OUT} is the output power, V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, and X is the differential reactance of the network.

Additionally, when the half-bridge rectifiers 1606, 1608 are configured in the parallel configuration and the half-bridge rectifiers 1606, 1608 are configured in the staked configuration, the phase shift angles, 2Δ and ϕ, can be determined as:

$$Δ = atan ( \frac{{π}^{2} {XP}_{OUT}}{2 {v}_{in , pk}^{2}} ) \qquad ( 27 )$$

$$ϕ = 2 asin ( \frac{{v}_{in , pk}}{{N V}_{OUT}} \sqrt{{v}_{r}^{2} + {( \frac{{π}^{2} {XP}_{OUT}}{2 {v}_{in , pk}^{2}} {v}_{r} )}^{2}} ) \qquad ( 28 )$$

wherein X is the differential reactance of the network, P_{OUT} is the output power, V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, and X is the differential reactance of the network.

Furthermore, when the half-bridge rectifiers 1606, 1608 are configured in the stacked configuration and the half-bridge rectifiers 1606, 1608 are configured in the staked configuration, the phase shift angles, 2Δ and ϕ, can be determined as:

$$Δ = atan ( \frac{2 {π}^{2} {XP}_{OUT}}{{v}_{in , pk}^{2}} ) \qquad ( 29 )$$

$$ϕ = 2 asin ( \frac{{v}_{in , pk}}{2 {N V}_{OUT}} \sqrt{{v}_{r}^{2} + {( \frac{2 {π}^{2} {XP}_{OUT}}{{v}_{in , pk}^{2}} {v}_{r} )}^{2}} ) \qquad ( 30 )$$

wherein X is the differential reactance of the network, P_{OUT} is the output power, V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, and X is the differential reactance of the network. As such, it should be appreciated that by using the parallel/stacked configuration operation on both the half-bridge inverters 106, 108 and the half-bridge rectifiers 1606, 1608 can enhance of the performance of the converter 1700 and ensure relatively high and flat efficiency across wide operating range.

Referring again to FIG. 17, as shown, the converter 1700 include a pair of bypass capacitors, Cᵢₙ₁ and Cᵢₙ₂, coupled across the legs of the half-bridge inverters 106, 108 and a pair of bypass capacitors, Cₒᵤₜ₁ and Cₒᵤₜ₂, coupled across the legs of the half-bridge rectifiers 1606, 1608. When the converter 1700 is operated with the half-bridge inverters 106, 108 in the stacked configuration, it is desirable that the voltages across bypass capacitors Cᵢₙ₁ and Cᵢₙ₂ (ν_{C}_{ᵢₙ₁} and ν_{C}_{ᵢₙ₂}) are relatively balanced, i.e.,

$${v}_{{C}_{in 1}} = {v}_{{C}_{in 2}} = \frac{\vert {v}_{in} \vert}{2} .$$

Similarly, when the converter 1700 is operated with the half-bridge rectifiers 1606, 1608 in the stacked configuration, it is desirable that the voltages across bypass capacitors Cₒᵤₜ₁ and Cₒᵤₜ₂ (ν_{C}_{ₒᵤₜ₁} and ν_{C}_{ₒᵤₜ₂}) are relatively balanced, i.e.,

$${v}_{{C}_{out 1}} = {v}_{{C}_{out 2}} = \frac{{V}_{OUT}}{2} .$$

For example, the higher-order harmonics in the output currents of two half-bridge inverters 106, 108 and component tolerance-related mismatches in the ICN's differential reactances may create an imbalance in the voltages across bypass capacitors Cᵢₙ₁ and Cᵢₙ₂ when the half-bridge inverters 106, 108 are configured in the stacked configuration. To mitigate such voltage imbalances, an active voltage balancing strategy may be employed.

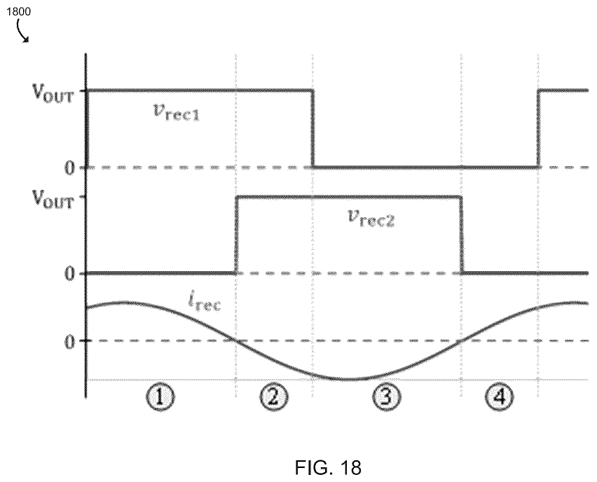

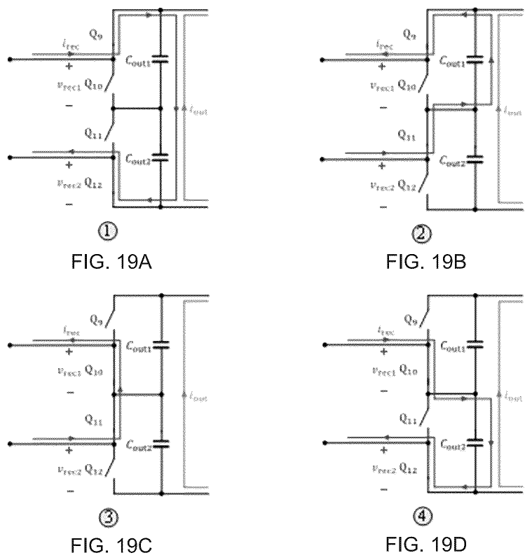

A similar issue can be seen in when half-bridge rectifiers 1606, 1608 are operated in the stacked configuration. Referring now to FIG. 18, a graph 1800 illustrates the switch node voltages and current of the two half-bridge rectifiers 1606, 1608 in an example fully soft-switched ICN converter 1700 while operating in a stacked configuration. As shown in FIG. 18, the half-bridge rectifiers 1606, 1608 operate in four states during a switching cycle, depending on the ON/OFF state of each switch 156. FIGS. 19A-19D shows illustrative circuit diagrams that trace the paths of the rectifier switch node current in each of the four states. As shown, state 1 (FIG. 19A), where current flows through both capacitors Cₒᵤₜ₁ and Cₒᵤₜ₂ and state 3 (FIG. 19C), where currents does not flow through any capacitor, do not create any imbalance in the capacitor voltages. However, in state 2 (FIG. 19B), current flows only through capacitor Cₒᵤₜ₁, and in state 4 (FIG. 19D), current flows only through capacitor Cₒᵤₜ₂. Considering the typical rectifier switch-node current waveform in a fully soft-switched ICN converter as shown in FIG. 18, the capacitor voltage imbalances result in the discharging of capacitor Cₒᵤₜ₁ in state 2 (FIG. 19B) and charging of capacitor C^{out2} in state 4 (FIG. 19D). Therefore, without a voltage balancing strategy, within a few switching cycles after turning on the converter 1700, the voltage across capacitor Cₒᵤₜ₁ may approach zero and the voltage across capacitor Cₒᵤₜ₂ may reach the output voltage V_{OUT}.

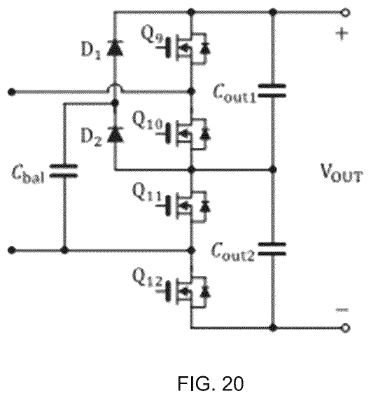

Accordingly, to address the above-described voltage imbalance issue in which the half-bridge rectifiers 1606, 1608 are in the stacked configuration, a passive voltage balancing strategy is implemented using a balancing capacitor C_{bal} and diodes D₁ and D₂, as shown in FIG. 20. In the proposed balancing circuit, during state 4 (FIG. 19D), the diode D₂ turns on, allowing the balancing capacitor C_{bal} to receive charge from capacitor Cₒᵤₜ₂. Whereas, during state 2 (FIG. 19B), the diode D₁ turns on, enabling the balancing capacitor C_{bal} to transfer charge to capacitor Cₒᵤₜ₁. Such an operation strategy ensures that the voltages across the capacitors Cₒᵤₜ₁ and Cₒᵤₜ₂ remain relatively balanced. The currents in the balancing circuit illustrated in FIG. 20 depend on the sizing of the balancing capacitor C_{bal}, which in turn dictates the losses in the associated balancing circuit. A higher balancing capacitance may be generally preferred to reduce the currents in the balancing circuit. For example, in an illustrative embodiment, a balancing capacitance value in the range of 5-10 μF may be chosen to maintain the current in the balancing circuit within desirable limits. The disclosed balancing circuit of FIG. 20 operates only when there is an imbalance in voltages across capacitors Cₒᵤₜ₁ and Cₒᵤₜ₂. Conversely, when the half-bridge rectifiers 1606, 1608 are operated in the parallel configuration, the voltages across capacitors Cₒᵤₜ₁ and Cₒᵤₜ₂ are relatively equal and negligible current flows through the balancing circuit.

The present disclosure describes a relatively high-efficiency bidirectional impedance control network-based AC-DC converter 100, 200 that employs a control methodology to ensure soft-switching of the converter switches while enabling reactive power capability, soft-switching, and voltage regulation. The disclosed technologies can be employed in across various applications including, but not limited to, onboard electric vehicle chargers, bidirectional onboard electric vehicle chargers, microinverters for solar or battery interfaced systems in residential and/or commercial installations, off-grid DC-to-AC power conversion, and other applications in which AC-to-DC or DC-to-AC converters are desired. As such, entities involved in the microinverter, solar, energy storage, utility generation and propagation, and off-grid energy industries may utilize the disclosed technologies, among others. Although specific embodiments of the proposed converter have been disclosed, it should be appreciated that the disclosed technologies may be used in various alternative embodiments including, but not limited to an ICN-based bidirectional AC-DC Converter with no auxiliary ZVS inductor, an ICN-based bidirectional AC-DC Converter with auxiliary ZVS inductor realized as discrete inductor to achieve soft switching of all transistors, an ICN-based DC-AC Converter with auxiliary ZVS inductor realized as discrete inductor to achieve soft switching of all transistors, an ICN-based DC-AC Converter with auxiliar ZVS inductor realized as magnetizing inductance of transformer to achieve soft switching of all transistors, a three-phase ICN-based AC-DC Converter, a three-phase ICN-based bidirectional AC-DC Converter, at hree-phase ICN-based bidirectional AC-DC Converter with auxiliary ZVS inductor realized as magnetizing inductance to achieve soft switching of all transistors, a three-phase ICN-based bidirectional AC-DC Converter with auxiliary ZVS inductor realized as discrete inductor to achieve soft switching of all transistors, a bidirectional ICN-based AC-DC power converter with multiple input or output ports, a bidirectional ICN-based DC-DC power converter with multiple input or output ports, a converter architecture with an auxiliary ZVS inductor realized using magnetizing inductance to achieve soft switching of all transistors; and/or a converter architecture with an auxiliary ZVS inductor realized using a discrete inductor to achieve soft switching of all transistors.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A bidirectional converter comprising:
a first rectifier circuit;
a first half-bridge inverter circuit electrically coupled to a common terminal of the first rectifier circuit and comprising a first plurality of transistors;
a second half-bridge inverter circuit electrically coupled the common terminal of the first rectifier circuit and comprising a second plurality of transistors;
a network having a first terminal electrically coupled to the first half-bridge inverter and a second terminal electrically coupled to the second half bridge inverter, wherein the network comprises (i) an impedance control network (ICN) when the bidirectional converter is operated in a forward operation mode and (ii) a resistance compression network (RCN) when the bidirectional converter is operated in a reverse operation mode;
an isolation transformer having a first terminal electrically coupled to a third terminal of the network and a pair of second terminals;
a second rectifier circuit electrically coupled to the pair of second terminals of the isolation transformer and comprising a third plurality of transistors; and
an inductive element established across the pair of second terminals of the isolation transformer, wherein the inductive element includes an inductance selected to produce zero voltage switching of the first, second, and third plurality of transistors.

2. The bidirectional converter of claim 1, wherein the inductive element comprises either (i) a magnetizing inductance of the isolation transformer or (ii) a discrete inductor.

3. The bidirectional converter of claim 1, wherein the inductance of the inductive element is determined according to the following equation:
$${L}_{ZVS} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} )$$
wherein L_{ZVS} is the inductance of the inductive element, N is the turns ratio of the isolation transformer, fₛ is the switching frequency of the bidirectional converter, V_{in,pk} is the peak value of an alternating current (AC) line voltage, P_{OUT} is the output power, and X is the differential reactance of the network.

4. The bidirectional converter of claim 1, wherein the inductance of the inductive element is determined according to the following equation:
$${L}_{ZVS , optimal} = \frac{X}{8 {N}^{2} {f}_{s}}$$
wherein L_{ZVS,optimal} is the inductance of the inductive element, X is the differential reactance of the network, N is the turns ratio of the isolation transformer, and fₛ is the switching frequency of the bidirectional converter.

5. The bidirectional converter of claim 1, wherein the isolation transformer has a turns ratio, N, determined according to the following equation:
$$N = \frac{\sqrt{{V}_{in , min , pk}^{2} + {V}_{in , max , pk}^{2}}}{2 {V}_{out , min}}$$
wherein V_{in,min,pk} is the peak value of a minimum alternating current (AC) line voltage, V_{in,max,pk} is the peak value of a maximum AC line voltage, and V_{out,min} is the minimum output Direct Current (DC) voltage.

6. The bidirectional converter of claim 1, wherein a differential reactance, X, of the network is determined according to the following equation:
$$X = \frac{2 {V}_{in , min , pk} {V}_{in , max , pk}}{{π}^{2} {P}_{OUT , rated}}$$
wherein V_{in,min,pk} is the peak value of a minimum alternating current (AC) line voltage, V_{in,max,pk} is the peak value of a maximum AC line voltage, and P_{OUT,rated} is the rated output power of the bidirectional converter.

7. The bidirectional converter of claim 1, further comprising a controller configured to control a phase shift angle, 2Δ, between the first half-bridge inverter circuit and the second half-bridge circuit and a phase shift angle, ϕ, between a first leg of the second rectifier circuit and a second leg of the second rectifier circuit.

8. The bidirectional converter of claim 7, wherein the phase shift angle, 2Δ, between the first half-bridge inverter circuit and the second half-bridge circuit is determined according to the following equation:
$$Δ = a tan ( \frac{{π}^{2} {XP}_{OUT}}{2 {v}_{in , pk}^{2}} z )$$
wherein X is the differential reactance of the network, P_{OUT} is the output power, and V_{in,pk} is the peak value of an alternating current (AC) line voltage.

9. The bidirectional converter of claim 7, wherein the phase shift angle, ϕ, between the first leg of the second rectifier circuit and the second leg of the second rectifier circuit is determined according to the following equation:
$$ϕ = 2 a sin ( \frac{{v}_{in , pk}}{2 {NV}_{OUT}} \sqrt{{v}_{r}^{2} + {( \frac{{π}^{2} {XP}_{OUT}}{2 {v}_{in , pk}^{2}} {zv}_{r} )}^{2}} )$$
wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, X is the differential reactance of the network, P_{OUT} is the output power, and Z is a factor value.

10. A converter comprising:
a first rectifier circuit having an input configured to receive an alternating current (AC) input signal, the first rectifier circuit being configured to convert the AC input signal to a rectified signal at an output of the first rectifier circuit;
a first half-bridge inverter circuit electrically coupled to the output of the first rectifier circuit and comprising a first plurality of transistors, the first half-bridge inverter being configured to convert the rectified signal to a first Direct Current (DC) signal at an output of the first half-bridge inverter circuit;
a second half-bridge inverter circuit electrically coupled to the output of the first rectifier circuit and comprising a second plurality of transistors, the second half-bridge inverter being configured to convert the rectified signal to a second DC signal at an output of the second half-bridge inverter circuit;
an impedance control network having a first input electrically coupled to the output of the first half-bridge inverter and a second input electrically coupled to the output of the second half bridge inverter, the impedance control network configured to combine the first DC signal and the second DC signal to generate a third DC signal at an output of the impedance control network;
an isolation transformer having an input electrically coupled to an output of the impedance control network and an output comprising a pair of output terminals;
a second rectifier circuit electrically coupled to the output of the isolation transformer, the second rectifier circuit comprising a third plurality of transistors and being configured to convert an output signal of the isolation transformer to a DC output signal; and
an inductive element established across the pair of output terminals of the isolation transformer, wherein the inductive element includes an inductance selected to produce zero voltage switching of the first, second, and third plurality of transistors.

11. The converter of claim 10, wherein the inductance of the inductive element is determined according to the following equation:
$${L}_{ZVS} \leq \frac{1}{16 {π}^{2} {N}^{2} {f}_{s}} ( \frac{2 {V}_{in , pk}^{2}}{{P}_{OUT}} + \frac{{π}^{4} {X}^{2} {P}_{OUT}}{2 {V}_{in , pk}^{2}} )$$
wherein L_{ZVS} is the inductance of the inductive element, N is the turns ratio of the isolation transformer, fₛ is the switching frequency of the converter, V_{in,pk} is the peak value of an alternating current (AC) line voltage, P_{OUT} is the output power, and X is the differential reactance of the network.

12. The converter of claim 10, wherein the inductance of the inductive element is determined according to the following equation:
$${L}_{ZVS , optimal} = \frac{X}{8 {N}^{2} {f}_{s}}$$
wherein L_{ZVS,optimal} is the inductance of the inductive element, X is the differential reactance of the network, N is the turns ratio of the isolation transformer, and fₛ is the switching frequency of the converter.

13. The converter of claim 10, wherein the isolation transformer has a turns ratio, N, determined according to the following equation:
$$N = \frac{\sqrt{{V}_{in , min , pk}^{2} + {V}_{in , max , pk}^{2}}}{2 {V}_{out , min}}$$
wherein V_{in,min,pk} is the peak value of a minimum alternating current (AC) line voltage, V_{in,max,pk} is the peak value of a maximum AC line voltage, and V_{out,min} is the minimum output Direct Current (DC) voltage.

14. The converter of claim 10, wherein a differential reactance, X, of the network is determined according to the following equation:
$$X = \frac{2 {V}_{in , min , pk} {V}_{in , max , pk}}{{π}^{2} {P}_{OUT , rated}}$$
wherein V_{in,min,pk} is the peak value of a minimum alternating current (AC) line voltage, V_{in,max,pk} is the peak value of a maximum AC line voltage, and P_{OUT,rated} is the rated output power of the converter.

15. The converter of claim 10, further comprising a controller configured to control a phase shift angle, 2Δ, between the first half-bridge inverter circuit and the second half-bridge circuit and a phase shift angle, ϕ, between a first leg of the second rectifier circuit and a second leg of the second rectifier circuit.

16. The converter of claim 15, wherein the phase shift angle, 2Δ, between the first half-bridge inverter circuit and the second half-bridge circuit is determined according to the following equation:
$$Δ = a tan ( \frac{{π}^{2} {XP}_{OUT}}{2 {v}_{in , pk}^{2}} z )$$
wherein X is the differential reactance of the network, P_{OUT} is the output power, and V_{in,pk} is the peak value of an alternating current (AC) line voltage.

17. The converter of claim 15, wherein the phase shift angle, ϕ, between the first leg of the second rectifier circuit and the second leg of the second rectifier circuit is determined according to the following equation:
$$ϕ = 2 a sin ( \frac{{v}_{in , pk}}{2 {NV}_{OUT}} \sqrt{{v}_{r}^{2} + {( \frac{{π}^{2} {XP}_{OUT}}{2 {v}_{in , pk}^{2}} {zv}_{r} )}^{2}} )$$
wherein V_{in,pk} is the peak value of an alternating current (AC) line voltage, N is the turns ratio of the isolation transformer, Vₒᵤₜ is the output voltage, Vᵣ is a ratio of the magnitude of an instantaneous alternating current (AC) line voltage and a peak AC line voltage, X is the differential reactance of the network, P_{OUT} is the output power, and Z is a factor value.

18. A method for controlling operation of a bidirectional converter including an impedance control network (ICN), the method comprising:
determining a ratio, Vᵣ, of a magnitude of the instantaneous line voltage of an alternating current (AC) input signal;
determining a reactive power capability factor, Z, as a function of the ratio, Vᵣ,;
determining a phase shift angle, 2Δ, between a first half-bridge inverter circuit and a second half-bridge circuit of the bidirectional converter based on the reactive power capability factor, Z;
determining a phase shift angle, ϕ, between a first leg and a second leg of a rectifier circuit of the bidirectional converter based on the reactive power capability factor, Z;
controlling operation of a plurality of transistors of the first and second half-bridge inverters circuit based on the phase shift angle, 2Δ; and
controlling operation of a plurality of transistors of the rectifier circuit inverter circuit based on the phase shift angle, ϕ.

19. The method of claim 18, wherein determining the phase shift angle, 2Δ, between the first half-bridge inverter circuit and the second half-bridge circuit comprises determining the phase shift angle, 2Δ, according to the following equation:
$$Δ = a tan ( \frac{{π}^{2} {XP}_{OUT}}{2 {v}_{in , pk}^{2}} z )$$
wherein X is the differential reactance of the impedance control network, P_{OUT} is the output power, and V_{in,pk} is the peak voltage value of AC input signal.

20. The method of claim 18, wherein determining the phase shift angle, ϕ, between a first leg and a second leg of a rectifier circuit comprises determining the phase shift angle, ϕ, according to the following equation:
$$ϕ = 2 a sin ( \frac{{v}_{in , pk}}{2 {NV}_{OUT}} \sqrt{{v}_{r}^{2} + {( \frac{{π}^{2} {XP}_{OUT}}{2 {v}_{in , pk}^{2}} {zv}_{r} )}^{2}} )$$
wherein V_{in,pk} is the peak voltage value of the AC input signal, N is the turns ratio of an isolation transformer of the bidirectional converter, Vₒᵤₜ is the output voltage, Vᵣ is a ratio of the magnitude of an instantaneous voltage of the AC input signal and a peak voltage of the AC input signal, X is the differential reactance of the impedance control network, P_{OUT} is the output power, and Z is the reactive power capability factor.
